(19) United States
(12) Patent Application Publication
(10) Pub. No.: US 2019/0362269 A1
(43) Pub. Date: Nov. 28, 2019

(54) METHODS AND APPARATUS TO SELF-GENERATE A MULTIPLE-OUTPUT ENSEMBLE MODEL DEFENSE AGAINST ADVERSARIAL ATTACKS

(71) Applicant: Intel Corporation, Santa Clara, CA (US)

(72) Inventor: Haim Barad, Zichron Yaakov (IL)

(21) Appl. No.: 16/538,409

(22) Filed: Aug. 12, 2019

(51) Int. Cl. G06N 20/20; G06N 3/04; G06F 17/15

(52) U.S. Cl. CPC G06N 20/20; G06F 17/15; G06N 3/0454

(57) ABSTRACT

Methods, apparatus, systems and articles of manufacture to self-generate a multiple-output ensemble model defense against adversarial attacks are disclosed. An example apparatus includes a model acquirer to acquire the model, an exit point quantity identifier to determine a number of exit points to place in the model, an exit point selector to select exit points to be enabled in the model, and an exit output generator to generate an additional model structure to calculate an output at each respective exit point.

### FIELD OF THE DISCLOSURE

This disclosure relates generally to defense against adversarial attacks, and, more particularly, to methods and apparatus to self-generate a multiple-output ensemble model defense against adversarial attacks.

### BACKGROUND

Adversarial attacks against artificial intelligence are malicious inputs crafted to compromise the accuracy of classification models. Although the strongest adversarial attacks utilize a model's characteristics, the construction of attacks does not require knowledge of a specific model's behavior, and small, imperceptible changes to inputs to a model can cause severe misclassifications. Adversarial attacks can cause serious damage to systems that rely on artificial intelligence models (e.g., automated driving, spam filtering, virus detection).

### BRIEF DESCRIPTION OF THE DRAWINGS

FIG. 1 is a schematic describing an example of a model used to generate and aggregate prediction outputs after varying numbers of layers.

FIG. 2A depicts an example environment of use including an example system to generate an ensemble model.

FIG. 2B is a block diagram of an example ensemble model generator to create and aggregate multiple exit points from a known model.

FIG. 3 is a flowchart representative of machine readable instructions which may be executed to implement the example ensemble model generator of FIG. 2B.

FIG. 4 is a flowchart representative of machine readable instructions which may be executed to implement the example client device of FIG. 2A.

FIG. 5 is a block diagram of an example processor platform structured to execute the instructions of FIGS. 3 and/or 4 to implement the example client device of FIG. 2A and the example ensemble model generator of FIG. 2B.

The figures are not to scale. In general, the same reference numbers will be used throughout the drawing(s) and accompanying written description to refer to the same or like parts. Connection references (e.g., attached, coupled, connected, and joined) are to be construed broadly and may include intermediate members between a collection of elements and relative movement between elements unless otherwise indicated. As such, connection references do not necessarily infer that two elements are directly connected and in fixed relation to each other. Stating that any part is in “contact” with another part means that there is no intermediate part between the two parts.

Descriptors “first,” “second,” “third,” etc. are used herein when identifying multiple elements or components which may be referred to separately. Unless otherwise specified or understood based on their context of use, such descriptors are not intended to impute any meaning of priority, physical order or arrangement in a list, or ordering in time but are merely used as labels for referring to multiple elements or components separately for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for ease of referencing multiple elements or components.

### DETAILED DESCRIPTION

Artificial intelligence (AI), including machine learning (ML), deep learning (DL), and/or other artificial machine-driven logic, enables machines (e.g., computers, logic circuits, etc.) to use a model to process input data to generate an output based on patterns and/or associations previously learned by the model via a training process. For instance, the model may be trained with data to recognize patterns and/or associations and follow such patterns and/or associations when processing input data such that other input(s) result in output(s) consistent with the recognized patterns and/or associations.

Recent years have witnessed advances in machine learning methods regarding early exits from a machine learning model. Early exit approaches determine whether a prediction confidence at an exit location exceeds a threshold confidence and, if so, immediately cease further calculations and returns the generated prediction.

In some examples, multiple models are used to create a prediction result. Such use of multiple models is referred to herein as an ensemble model. Ensemble models enable a reduction of the variance and error rate of predictions. Further, an ensemble model can enable the detection of adversarial attacks in the form of inputs that are maliciously perturbed in order to compromise the accuracy of a model. To develop a traditional ensemble model, multiple models are trained in parallel. To make a prediction from the ensemble model, each model accepts the input and produces an output prediction. The predictions from the models are combined together to produce a final prediction.

Traditionally, ensemble models are generated through the combination of multiple trained machine learning models with varying parameters. However, applications can benefit from the calculation of predictions at multiple exit locations. The collection of outputs gathered from each exit location enables the creation of an ensemble model. The generation of an ensemble model from a single trained model reduces the number of models that require training to be incorporated into an ensemble model. Further, the use of a single trained model can result in fewer computational steps required for model training.

Examples disclosed herein can be used to generate an ensemble model from a single trained model. Further, examples disclosed herein enable enhanced detection of adversarial attacks against the trained model. Predictions generated by the ensemble model may be analyzed to, for example, monitor the level of inconsistencies between outputs at exits throughout the ensemble model and respond when the level of inconsistencies exceeds a certain threshold.

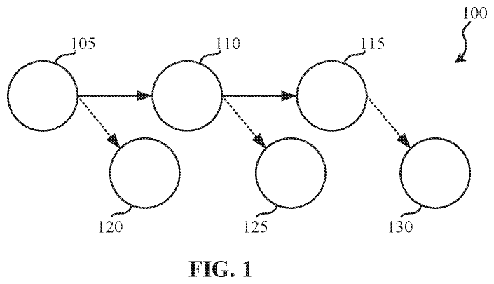

FIG. 1 is a schematic describing an example of a multi-output ensemble model used to generate a set of outputs either followed or not followed by another example selection of layers in the model. FIG. 1 describes an ensemble model 100. In examples disclosed herein, the ensemble model 100 includes layer sections 105, 110, 115. A layer section can contain one or multiple layers in a machine learning model. Although the ensemble model layers are divided into three layer sections 105, 110, 115, an ensemble model can have any number of layer sections. Further, although the layer sections are organized by type of layer, a layer section can contain varying layer types. After input data has been processed through a layer section, an output for the layer section is sent to both a corresponding output layer group and a layer section directly adjacent to the layer section. The first layer section 105 provides an output to the second layer section 110 and the first output layer 120. The second layer section 110 provides an output to the third layer section 115 and the second output layer 125. The third layer section 115 provides an output to the third output layer 130.

Though each layer section 105, 110, 115 in this example directs the processed data to the corresponding output layer 120, 125, 130, a layer section can have one or more connected output layers. In this example, each output layer calculates a classification for the input given. However, any output value type can be calculated (e.g., binary classification, multiclass classification, confidence score). Further, an output layer 120, 125, 130 can generate one or more types of output values.

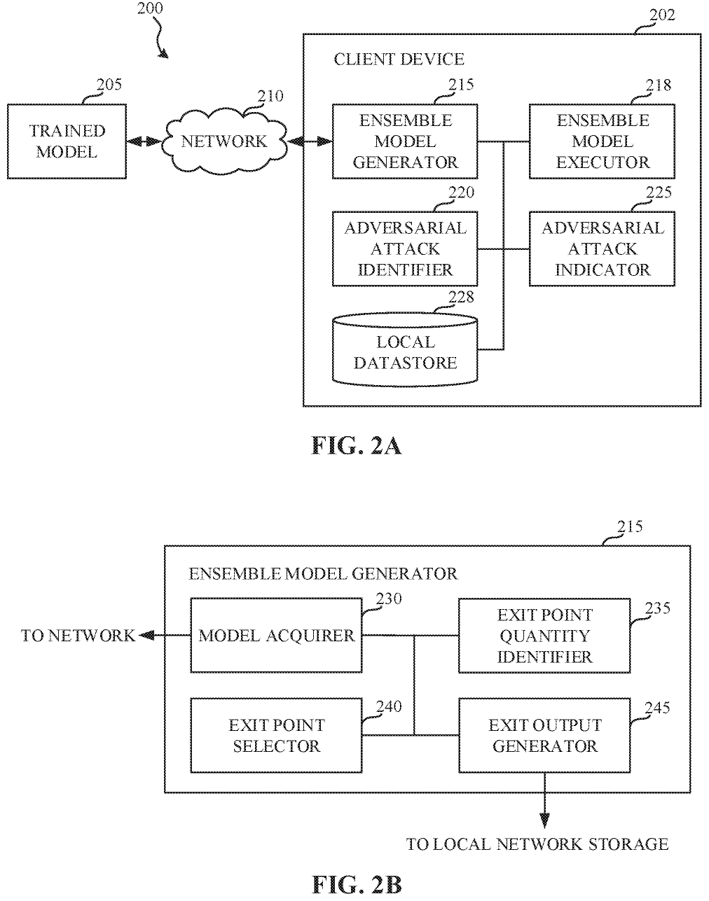

FIG. 2A depicts an example environment 200 of use including an example system to generate an ensemble model. The example environment 200 of FIG. 2A includes a client device 202, a trained model 205, and a network 210. In examples disclosed herein, the trained model 205 represents a model (e.g., deep learning neural network) that identifies a classification for an input image and a classification confidence score. However, any other trained model may additionally or alternatively be used. The client device 202 of FIG. 2A includes an example ensemble model generator 215, an example ensemble model executor 218, an adversarial attack identifier 220, an adversarial attack indicator 225, and a local datastore 228.

The example ensemble model generator 215 of the illustrated example of FIG. 2A is implemented by a logic circuit such as, for example, a hardware processor. However, any other type of circuitry may additionally or alternatively be used such as, for example, one or more analog or digital circuit(s), logic circuits, programmable processor(s), application specific integrated circuit(s) (ASIC(s)), programmable logic device(s) (PLD(s)), field programmable logic device(s) (FPLD(s)), digital signal processor(s) (DSP(s)), graphics processing units (GPUs), etc. The example ensemble model generator 215 intakes a model that is already trained and generates an ensemble model of multiple output points using the trained model 205. In the examples disclosed herein, the example ensemble model generator 215 stores the generated ensemble model in the local datastore 228. However, any other datastore may additionally and/or alternatively used. For example, the example model generator 215 may store the ensemble model on a device via a network.

The example model executor 218 of the illustrated example of FIG. 2A is implemented by a logic circuit such as, for example, a hardware processor. However, any other type of circuitry may additionally or alternatively be used such as, for example, one or more analog or digital circuit(s), logic circuits, programmable processor(s), ASIC(s), PLD(s), FPLD(s), programmable controller(s), GPU(s), DSP(s), etc. The example model executor 218 executes the ensemble model generated by the example model generator 215. In the examples disclosed herein, the example model executor 218 generates an output using one output location in the ensemble model. However, other output locations may be additionally and/or alternatively used. For example, the example model executor 218 may aggregate results of the ensemble model output locations placed by the example ensemble model generator 215 into an output using a weighted average.

The example adversarial attack identifier 220 of the illustrated example of FIG. 2A is implemented by a logic circuit such as, for example, a hardware processor. However, any other type of circuitry may additionally or alternatively be used such as, for example, one or more analog or digital circuit(s), logic circuits, programmable processor(s), ASIC(s), PLD(s), FPLD(s), programmable controller(s), GPU(s), DSP(s), etc. The example adversarial attack identifier 220 identifies whether an input to the ensemble model is an adversarial attack using the output of the ensemble model at multiple output locations. In some examples, the example adversarial attack identifier 220 determines an adversarial attack has occurred using a distribution of confidence scores reported by output locations in the ensemble model and a threshold of the deviation of confidence scores. In other examples, the example adversarial attack identifier 220 determines an adversarial attack has occurred using a count of classifications reported by output locations in the ensemble model.

The example adversarial attack indicator 225 of the illustrated example of FIG. 2A is implemented by a logic circuit such as, for example, a hardware processor. However, any other type of circuitry may additionally or alternatively be used such as, for example, one or more analog or digital circuit(s), logic circuits, programmable processor(s), ASIC(s), PLD(s), FPLD(s), programmable controller(s), GPU(s), DSP(s), etc. The example adversarial attack indicator 225 indicates to a user and/or client that an adversarial attack input on the ensemble model was detected. In the examples disclosed herein, the example adversarial attack indicator 225 stores a time at which an attack was identified and the input given to the ensemble model in the local datastore 228. However, any other method of indicating an adversarial attack may additionally and/or alternatively used. For example, the example adversarial attack indicator may notify a user of an adversarial attack via a user interface.

The example local datastore 228 of the illustrated example of FIG. 2A is implemented by any memory, storage device and/or storage disc for storing data such as, for example, flash memory, magnetic media, optical media, solid state memory, hard drive(s), thumb drive(s), etc. Furthermore, the data stored in the example local datastore 228 may be in any data format such as, for example, binary data, comma delimited data, tab delimited data, structured query language (SQL) structures, etc. While, in the illustrated example, the example local datastore 228 is illustrated as a single device, the example local datastore 228 and/or any other data storage devices described herein may be implemented by any number and/or type(s) of memories. In the illustrated examples of FIGS. 2A and/or 2B, the example local datastore 228 stores the ensemble model generated by the example ensemble model generator 215, the output of the ensemble model calculated by the example ensemble model executor 218, and indications of adversarial attacks from the example adversarial attack indicator 225.

FIG. 2B is a block diagram of an example ensemble model generator 215 to create additional output generators on a machine learning model. The example ensemble model generator 215 of FIG. 2B includes an example model acquirer 230, an example exit point quantity identifier 235, an example exit point selector 240, and an example exit output generator 245. The example ensemble model generator 215 intakes a model that is already trained.

The example model acquirer 230 of the illustrated example of FIG. 2B is implemented by a logic circuit such as, for example, a hardware processor. However, any other type of circuitry may additionally or alternatively be used such as, for example, one or more analog or digital circuit(s), logic circuits, programmable processor(s), ASIC(s), PLD(s), FPLD(s), programmable controller(s), GPU(s), DSP(s), etc. The example model acquirer 230 accesses a trained model 205 that identifies a classification for an input image and a classification confidence score. However, any other trained model may be alternatively used. In some examples, the trained model 205 is a remote dataset (e.g., a dataset stored at a remote location and/or server). In some examples, the trained model 205 is stored locally to the example local datastore 228. The model acquirer 230 may implement means for acquiring.

The example exit point quantity identifier 235 of the illustrated example of FIG. 2B is implemented by a logic circuit such as, for example, a hardware processor. However, any other type of circuitry may additionally or alternatively be used such as, for example, one or more analog or digital circuit(s), logic circuits, programmable processor(s), ASIC(s), PLD(s), FPLD(s), programmable controller(s), GPU(s), DSP(s), etc. The example exit point quantity identifier 235 determines the number of additional exit points to be placed onto the trained model 205. In some examples, the number of additional exit points to be placed is determined by a number of model layers (e.g., convolutional layers) with a cost that exceeds a certain threshold. In other examples, the number of additional exit points to be placed is determined through the use of a mapping of model type to number of points, user defined, etc. The example exit point quantity identifier 235 may implement means for identifying.

The example exit point selector 240 of the illustrated example of FIG. 2B is implemented by a logic circuit such as, for example, a hardware processor. However, any other type of circuitry may additionally or alternatively be used such as, for example, one or more analog or digital circuit(s), logic circuits, programmable processor(s), ASIC(s), PLD(s), FPLD(s), programmable controller(s), GPU(s), DSP(s), etc. The example exit point selector 240 determines the locations in the model 205 at which additional output points will be placed. In the examples disclosed herein, the additional output point locations are determined by the location of expensive model layers (e.g., convolutional layers). In some examples, the additional output locations can be selected by testing the model with varying sets of exit combinations and selecting the location set with the lowest cross entropy loss. The example exit point selector 240 may implement means for selecting.

The example exit output generator 245 of the illustrated example of FIG. 2B is implemented by a logic circuit such as, for example, a hardware processor. However, any other type of circuitry may additionally or alternatively be used such as, for example, one or more analog or digital circuit(s), logic circuits, programmable processor(s), ASIC(s), PLD(s), FPLD(s), programmable controller(s), GPU(s), DSP(s), etc. The example exit output generator 245 places additional model layers at the points determined by the example exit point selector 240. The model layers placed by the example exit output generator 245 generate a usable output value from the model exit point. In the examples enclosed herein, the additional model layers include a fully connected layer and a softmax layer. However, other layer types may additionally and/or alternatively be used (e.g., convolutional layers, pooling layers). In the examples enclosed herein, the example exit output generator 245 places two additional model layers at the exit location. However, the example exit output generator 250 can place more or fewer layers at each exit point. The example exit output generator 245 may implement means for generating.

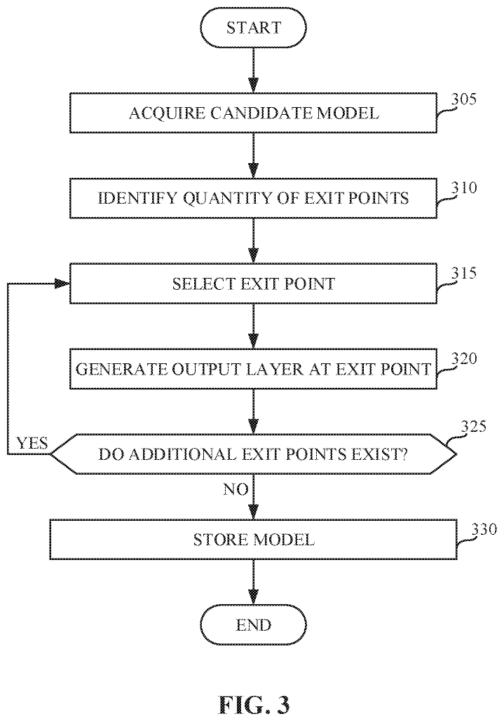

While an example manner of implementing the client device 202 is illustrated in FIG. 2A and an example manner of implementing the ensemble model generator is illustrated in FIG. 2B, one or more of the elements, processes and/or devices illustrated in FIGS. 2A and/or 2B may be combined, divided, re-arranged, omitted, eliminated and/or implemented in any other way. Further, the example ensemble model generator 215, the example ensemble model executor 218, the example adversarial attack identifier 220, the example adversarial attack indicator 225, the example model acquirer 230, the example exit point quantity identifier 235, the example exit point selector 240, the example exit output generator 245, and/or, more generally, the example client device of FIG. 2A, and/or the example ensemble model generator of FIG. 2B may be implemented by hardware, software, firmware and/or any combination of hardware, software and/or firmware. Thus, for example, any of the example ensemble model generator 215, the example ensemble model executor 218, the example adversarial attack identifier 220, the example adversarial attack indicator 225, the example model acquirer 230, the example exit point quantity identifier 235, the example exit point selector 240, the example exit output generator 245, and/or, more generally, the example ensemble model generator of FIGS. 2A and/or 2B and/or, more generally, the example client device of FIG. 2A, and/or the example ensemble model generator of FIG. 2B could be implemented by one or more analog or digital circuit(s), logic circuits, programmable processor(s), programmable controller(s), graphics processing unit(s) (GPU(s)), digital signal processor(s) (DSP(s)), application specific integrated circuit(s) (ASIC(s)), programmable logic device(s) (PLD(s)) and/or field programmable logic device(s) (FPLD(s)). When reading any of the apparatus or system claims of this patent to cover a purely software and/or firmware implementation, at least one of the example, ensemble model generator 215, the example ensemble model executor 218, the example adversarial attack identifier 220, the example adversarial attack indicator 225, the example model acquirer 230, the example exit point quantity identifier 235, the example exit point selector 240, and the example exit output generator 245 is/are hereby expressly defined to include a non-transitory computer readable storage device or storage disk such as a memory, a digital versatile disk (DVD), a compact disk (CD), a Blu-ray disk, etc. including the software and/or firmware. Further still, the example client device 202 of FIG. 2A and/or the example ensemble model generator 215 of FIG. 2B may include one or more elements, processes and/or devices in addition to, or instead of, those illustrated in FIGS. 3 and/or 4, and/or may include more than one of any or all of the illustrated elements, processes and devices. As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

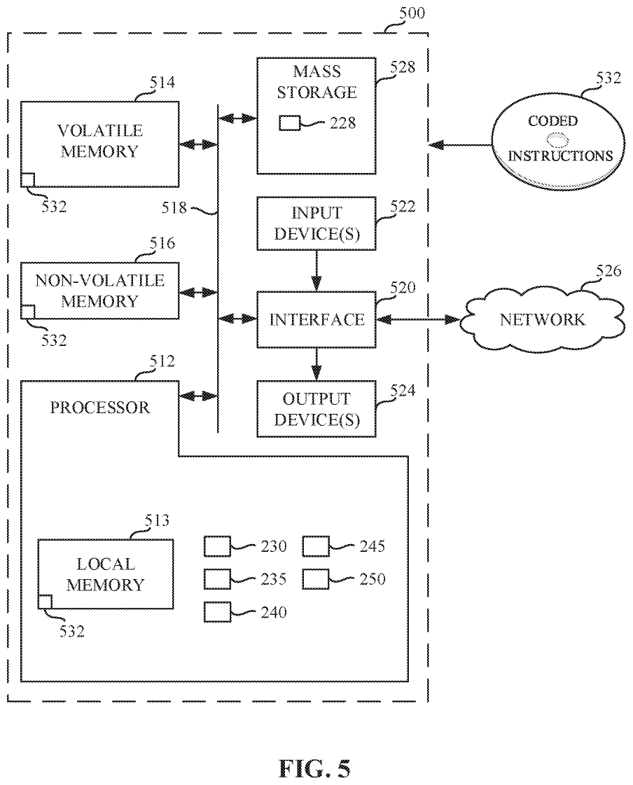

Flowcharts representative of example hardware logic, machine readable instructions, hardware implemented state machines, and/or any combination thereof for implementing the example client device 202 of FIG. 2A and/or the example ensemble model generator 215 of FIG. 2B is shown in FIGS. 3 and/or 4. The machine readable instructions may be one or more executable programs or portion(s) of an executable program for execution by a computer processor such as the processor 512 shown in the processor platform 500 discussed below in connection with FIG. 5. The program may be embodied in software stored on a non-transitory computer readable storage medium such as a CD-ROM, a floppy disk, a hard drive, a DVD, a Blu-ray disk, or a memory associated with the processor 5152, but the entire program and/or parts thereof could alternatively be executed by a device other than the processor 512 and/or embodied in firmware or dedicated hardware. Further, although the example program is described with reference to the flowcharts illustrated in FIGS. 3 and/or 4, many other methods of implementing the example client device 202 or the example ensemble model generator 215 may alternatively be used. For example, the order of execution of the blocks may be changed, and/or some of the blocks described may be changed, eliminated, or combined. Additionally or alternatively, any or all of the blocks may be implemented by one or more hardware circuits (e.g., discrete and/or integrated analog and/or digital circuitry, an FPGA, an ASIC, a comparator, an operational-amplifier (op-amp), a logic circuit, etc.) structured to perform the corresponding operation without executing software or firmware.

The machine readable instructions described herein may be stored in one or more of a compressed format, an encrypted format, a fragmented format, a compiled format, an executable format, a packaged format, etc. Machine readable instructions as described herein may be stored as data (e.g., portions of instructions, code, representations of code, etc.) that may be utilized to create, manufacture, and/or produce machine executable instructions. For example, the machine readable instructions may be fragmented and stored on one or more storage devices and/or computing devices (e.g., servers). The machine readable instructions may require one or more of installation, modification, adaptation, updating, combining, supplementing, configuring, decryption, decompression, unpacking, distribution, reassignment, compilation, etc. in order to make them directly readable, interpretable, and/or executable by a computing device and/or other machine. For example, the machine readable instructions may be stored in multiple parts, which are individually compressed, encrypted, and stored on separate computing devices, wherein the parts when decrypted, decompressed, and combined form a set of executable instructions that implement a program such as that described herein.

In another example, the machine readable instructions may be stored in a state in which they may be read by a computer, but require addition of a library (e.g., a dynamic link library (DLL)), a software development kit (SDK), an application programming interface (API), etc. in order to execute the instructions on a particular computing device or other device. In another example, the machine readable instructions may need to be configured (e.g., settings stored, data input, network addresses recorded, etc.) before the machine readable instructions and/or the corresponding program(s) can be executed in whole or in part. Thus, the disclosed machine readable instructions and/or corresponding program(s) are intended to encompass such machine readable instructions and/or program(s) regardless of the particular format or state of the machine readable instructions and/or program(s) when stored or otherwise at rest or in transit.

The machine readable instructions described herein can be represented by any past, present, or future instruction language, scripting language, programming language, etc. For example, the machine readable instructions may be represented using any of the following languages: C, C++, Java, C#, Perl, Python, JavaScript, HyperText Markup Language (HTML), Structured Query Language (SQL), Swift, etc.

As mentioned above, the example processes of FIGS. 3 and/or 4 may be implemented using executable instructions (e.g., computer and/or machine readable instructions) stored on a non-transitory computer and/or machine readable medium such as a hard disk drive, a flash memory, a read-only memory, a compact disk, a digital versatile disk, a cache, a random-access memory and/or any other storage device or storage disk in which information is stored for any duration (e.g., for extended time periods, permanently, for brief instances, for temporarily buffering, and/or for caching of the information). As used herein, the term non-transitory computer readable medium is expressly defined to include any type of computer readable storage device and/or storage disk and to exclude propagating signals and to exclude transmission media.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc. may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, and (7) A with B and with C. As used herein in the context of describing structures, components, items, objects and/or things, the phrase “at least one of A and B” is intended to refer to implementations including any of (1) at least one A, (2) at least one B, and (3) at least one A and at least one B. Similarly, as used herein in the context of describing structures, components, items, objects and/or things, the phrase “at least one of A or B” is intended to refer to implementations including any of (1) at least one A, (2) at least one B, and (3) at least one A and at least one B. As used herein in the context of describing the performance or execution of processes, instructions, actions, activities and/or steps, the phrase “at least one of A and B” is intended to refer to implementations including any of (1) at least one A, (2) at least one B, and (3) at least one A and at least one B. Similarly, as used herein in the context of describing the performance or execution of processes, instructions, actions, activities and/or steps, the phrase “at least one of A or B” is intended to refer to implementations including any of (1) at least one A, (2) at least one B, and (3) at least one A and at least one B.

FIG. 3 is a flowchart representative of machine-readable instructions which may be executed to implement the example ensemble model generator of FIG. 2B. As noted above, Artificial intelligence (AI), including machine learning (ML), deep learning (DL), and/or other artificial machine-driven logic, enables machines (e.g., computers, logic circuits, etc.) to use a model to process an initial data set to create malware detection rules and a machine learning model that utilizes the outputs of those rules to detect malware.

In general, implementing a ML/AI system involves two phases, a learning/training phase and an inference phase. In the learning/training phase, a training algorithm is used to train a model to operate in accordance with patterns and/or associations based on, for example, training data. In general, the model includes internal parameters that guide how input data is transformed into output data, such as through a series of nodes and connections within the model to transform input data into output data. Once training is complete, the model 205 is obtained by the model acquirer 230 as an executable construct that processes an input and provides output based on nodes and connections defined in the model. (Block 305). In examples disclosed herein, the trained model 205 represents a deep learning neural model that identifies a classification for an input (e.g., an image). However, any other trained model may be alternatively used. In examples herein, the model is accessed via a network such as the Internet. However, any other approach to distributing models may be additionally or alternatively used.

The example exit point quantity identifier 235 analyzes the model 205 to determine a number of additional exit points to be placed into the model 205. (Block 310). In the examples disclosed herein, the number of additional exit points to be placed is determined by identifying a cost to an exit location. An additional exit point is placed at an exit location if the identified cost exceeds a cost threshold. In other examples, the example exit point quantity identifier 235 identifies a maximum number of exit points to be placed and identifies exit locations using layers that have the highest cost values.

In the examples disclosed herein, the cost is determined using the number of nodes in a layer. However, other costs can additionally and/or alternatively be used (e.g., type of layer, estimated processing time, distance from a node location in the network). Further, in some examples, the number of additional exit points to be placed is determined through the use of a mapping of model type to number of points, user defined, cross entropy thresholds, heuristics, etc.

The example exit point selector 240 determines where additional model outputs are to be placed. (Block 315). In the examples disclosed herein, the additional output point locations are determined using a cost threshold. In some examples, the additional output locations can be selected by testing the model with varying sets of exit combinations and selecting the location set with the lowest cross-entropy loss. The example exit point selector 240 may identify a set of possible exit location combinations. The model 205 is tested with example inputs, and the weighted combination of exit losses is calculated as the cross-entropy loss. The example exit point selector 240 determines an exit location combination with the lowest cross-entropy loss as the locations where additional model outputs are to be placed.

The example exit output generator 245 places additional model layers at each of the additional output locations determined by the example exit point selector. (Block 320). In examples enclosed herein, the additional model layers include a fully connected layer and a softmax layer. For example, a fully connected layer and a softmax layer may be added as an output layer 120 to a layer section 105. However, other layer types may additionally and/or alternatively be used (e.g., convolutional layers, pooling layers). In the examples enclosed herein, the example exit output generator 245 places two additional model layers at the exit location. However, the example exit output generator 245 can place more or fewer layers at each exit point.

If the example exit point quantity identifier 235 determines that there are additional exit points to be examined (e.g., block 325 returns a result of YES), the example exit point selector 240 selects the next exit point. (Block 315). If the example exit point quantity identifier 235 determines that there are no more additional exit points to be examined (e.g., block 325 returns a result of NO), the ensemble model is stored. In the examples disclosed herein, the ensemble model is stored in the local datastore 228. (Block 330). In other examples, the ensemble model can be stored in an external location such as a cloud server.

Once trained, the deployed ensemble model may be operated in an inference phase to process data. In the inference phase, data to be analyzed (e.g., live data) is input to the ensemble model, and the model executes to create outputs at various exit locations. This inference phase can be thought of as the AI “thinking” to generate outputs based on what it learned from the training (e.g., by executing the ensemble model to apply the learned patterns and/or associations to the live data). In some examples, input data undergoes pre-processing before being used as an input to the machine learning model. Moreover, in some examples, the output data may undergo post-processing after it is generated by the AI model to transform the output into a useful result (e.g., a display of data, an instruction to be executed by a machine, etc.) For example, the multiple outputs generated by the ensemble model may be aggregated into a single probability distribution using weighted averaging.

In some examples, output of the deployed model may be captured and provided as feedback. By analyzing the feedback, an accuracy of the deployed model can be determined. If the feedback indicates that the accuracy of the deployed model is less than a threshold or other criterion, training of an updated model can be triggered using the feedback and an updated training data set, hyperparameters, etc., to generate an updated, deployed model. After the deployed model is retrained, the additional output points in the model may be again identified and constructed.

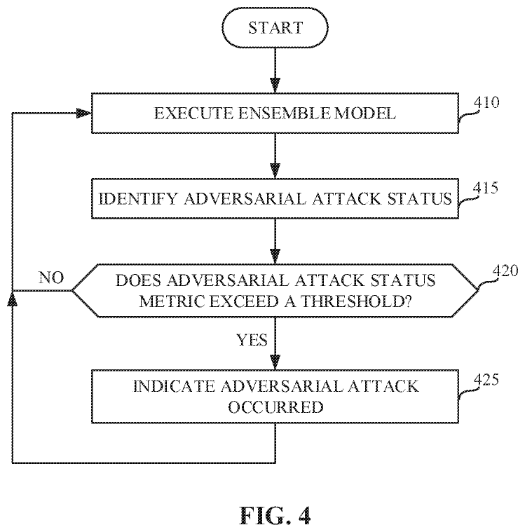

FIG. 4 is a flowchart representative of machine-readable instructions which may be executed to implement the example client device of FIG. 2A. The example model executor 218 executes the ensemble model generated by the example model generator 215. (Block 410). In the examples disclosed herein, the example model executor 218 generates an output using one output location in the ensemble model. However, other output locations may be additionally and/or alternatively used. For example, the example model executor 218 may aggregate results of the ensemble model output locations placed by the example ensemble model generator 215 into an output using a weighted average.

The example adversarial attack identifier 220 identifies whether an input to the ensemble model is an adversarial attack using the output of the ensemble model at multiple output locations. (Block 415). In some examples, the example adversarial attack identifier 220 determines an adversarial attack has occurred using a distribution of confidence scores reported by output locations in the ensemble model. In other examples, the example adversarial attack identifier 220 determines an adversarial attack has occurred using a count of classifications reported by output locations in the ensemble model.

If the example adversarial attack identifier 220 determines that an adversarial attack has occurred (e.g., block 420 returns a result of YES), the example adversarial attack indicator 225 indicates to a user and/or client that an adversarial attack input on the ensemble model was detected. (Block 425). In the examples disclosed herein, the example adversarial attack indicator 225 stores a time at which an attack was identified and the input given to the ensemble model in the local datastore 228. However, any other method of indicating an adversarial attack may additionally and/or alternatively used. For example, the example adversarial attack indicator may notify a user of an adversarial attack via a user interface. If the example adversarial attack identifier 220 does not determine that an adversarial attack has occurred (e.g., block 420 returns a result of NO), the example adversarial attack indicator 225 prompts the ensemble model executor 218 to execute the ensemble model for a subsequent input. (Block 410).

FIG. 5 is a block diagram of a processor platform 500 structured to execute the instructions of FIGS. 3 and/or 4 to implement the example client device 202 of FIG. 2A and/or the example ensemble model generator 215 of FIG. 2B. The processor platform 500 can be, for example, a server, a personal computer, a workstation, a self-learning machine (e.g., a neural network), a mobile device (e.g., a cell phone, a smart phone, a tablet such as an iPad™), a personal digital assistant (PDA), an Internet appliance, a DVD player, a CD player, a digital video recorder, a Blu-ray player, a gaming console, a personal video recorder, a set top box, a headset or other wearable device, or any other type of computing device.

The processor platform 500 of the illustrated example includes a processor 512. The processor 512 of the illustrated example is hardware. For example, the processor 512 can be implemented by one or more integrated circuits, logic circuits, microprocessors, GPUs, DSPs, or controllers from any desired family or manufacturer. The hardware processor may be a semiconductor based (e.g., silicon based) device. In this example, the processor implements the example model acquirer 230, the example exit point quantity identifier 235, the example exit point selector 240, and the example exit output generator 245.

The processor 512 of the illustrated example includes a local memory 513 (e.g., a cache). The processor 512 of the illustrated example is in communication with a main memory including a volatile memory 514 and a non-volatile memory 516 via a bus 518. The volatile memory 514 may be implemented by Synchronous Dynamic Random Access Memory (SDRAM), Dynamic Random Access Memory (DRAM), RAMBUS® Dynamic Random Access Memory (RDRAM®) and/or any other type of random access memory device. The non-volatile memory 516 may be implemented by flash memory and/or any other desired type of memory device. Access to the main memory 514, 516 is controlled by a memory controller.

The processor platform 500 of the illustrated example also includes an interface circuit 520. The interface circuit 520 may be implemented by any type of interface standard, such as an Ethernet interface, a universal serial bus (USB), a Bluetooth® interface, a near field communication (NFC) interface, and/or a PCI express interface.

In the illustrated example, one or more input devices 522 are connected to the interface circuit 520. The input device(s) 522 permit(s) a user to enter data and/or commands into the processor 512. The input device(s) can be implemented by, for example, an audio sensor, a microphone, a camera (still or video), a keyboard, a button, a mouse, a touchscreen, a track-pad, a trackball, isopoint and/or a voice recognition system.

One or more output devices 524 are also connected to the interface circuit 520 of the illustrated example. The output devices 524 can be implemented, for example, by display devices (e.g., a light emitting diode (LED), an organic light emitting diode (OLED), a liquid crystal display (LCD), a cathode ray tube display (CRT), an in-place switching (IPS) display, a touchscreen, etc.), a tactile output device, a printer and/or speaker. The interface circuit 520 of the illustrated example, thus, typically includes a graphics driver card, a graphics driver chip and/or a graphics driver processor.

The interface circuit 520 of the illustrated example also includes a communication device such as a transmitter, a receiver, a transceiver, a modem, a residential gateway, a wireless access point, and/or a network interface to facilitate exchange of data with external machines (e.g., computing devices of any kind) via a network 526. The communication can be via, for example, an Ethernet connection, a digital subscriber line (DSL) connection, a telephone line connection, a coaxial cable system, a satellite system, a line-of-site wireless system, a cellular telephone system, etc.

The processor platform 500 of the illustrated example also includes one or more mass storage devices 528 for storing software and/or data. Examples of such mass storage devices 528 include floppy disk drives, hard drive disks, compact disk drives, Blu-ray disk drives, redundant array of independent disks (RAID) systems, and digital versatile disk (DVD) drives.

The machine executable instructions 532 of FIGS. 3 and/or 4 may be stored in the mass storage device 528, in the volatile memory 514, in the non-volatile memory 516, and/or on a removable non-transitory computer readable storage medium such as a CD or DVD.

As used herein, singular references (e.g., “a”, “an”, “first”, “second”, etc.) do not exclude a plurality. The term “a” or “an” entity, as used herein, refers to one or more of that entity. The terms “a” (or “an”), “one or more”, and “at least one” can be used interchangeably herein. Furthermore, although individually listed, a plurality of means, elements or method actions may be implemented by, e.g., a single unit or processor. Additionally, although individual features may be included in different examples or claims, these may possibly be combined, and the inclusion in different examples or claims does not imply that a combination of features is not feasible and/or advantageous.

From the foregoing, it will be appreciated that example methods, apparatus and articles of manufacture have been disclosed that enable the creation of a multiple-output ensemble model for defense against adversarial attacks. The disclosed methods, apparatus and articles of manufacture improve the efficiency of using a computing device by efficiently generating an ensemble model from a single model rather than generating an ensemble model from multiple trained models. Utilizing a single model to create an ensemble model will be computationally more efficient than creating an ensemble model from a large set of distinctly trained models. The disclosed methods, apparatus and articles of manufacture are accordingly directed to one or more improvement(s) in the functioning of a computer.

Example methods, apparatus, systems, and articles of manufacture to self-generate a multiple-output ensemble model defense against adversarial attacks are disclosed herein. Further examples and combinations thereof include the following:

Example 1 includes an apparatus to generate an ensemble model from a trained machine learning model, the apparatus comprising a model acquirer to acquire the model, an exit point quantity identifier to determine a number of exit points to place in the model, an exit point selector to select exit points to be enabled in the model, and an exit output generator to generate an additional model structure to calculate an output at each respective exit point.

Example 2 includes the apparatus of example 1, wherein the model obtained by the model acquirer includes multiple trained models.

Example 3 includes the apparatus of example 1, wherein the exit point quantity identifier is to determine the number of exit points to be placed using a count of convolutional layers in the model.

Example 4 includes the apparatus of example 1, wherein the exit point quantity identifier is to determine the number of exit points to be placed by mapping a type of layer to the number of exit points.

Example 5 includes the apparatus of example 1, wherein the exit point selector identifies the exit points using cross entropy loss.

Example 6 includes the apparatus of example 1, wherein the exit output generator creates the additional model structure using an insertion of a fully connected layer and a softmax layer.

Example 7 includes the apparatus of example 1, wherein the exit output generator creates the additional model structure at each exit point that incorporates a calculated importance weight.

Example 8 includes At least one non-transitory computer readable medium comprising instructions that, when executed, cause at least one processor to at least acquire a model, identify a number of exit points to place in the model, select exit points to be enabled in the model, and generate an additional model structure to calculate an output at each respective exit point.

Example 9 includes the at least one non-transitory computer readable medium of example 8, wherein the instructions, when executed, cause the at least one processor to acquire the model by acquiring multiple trained models.

Example 10 includes the at least one non-transitory computer readable medium of example 8, wherein the instructions, when executed, cause the at least one processor to identify a number of exit points by counting a number of convolutional layers in the model.

Example 11 includes the at least one non-transitory computer readable medium of example 8, wherein the instructions, when executed, cause the at least one processor to identify the number of exit points by mapping a type of layer to the number of exit points.

Example 12 includes the at least one non-transitory computer readable medium of example 8, wherein the instructions, when executed, cause the at least one processor to select the exit points that will be enabled in the model by identifying a set of exit locations out of a set of varying exit locations using cross entropy loss.

Example 13 includes the at least one non-transitory computer readable medium of example 8, wherein the instructions, when executed, cause the at least one processor to generate the additional model structure by inserting a fully connected layer and a softmax layer at each exit point.

Example 14 includes the at least one non-transitory computer readable medium of example 8, wherein the instructions, when executed, cause the at least one processor to generate the additional model structures at each exit point by incorporating a calculated importance weight.

Example 15 includes the at least one non-transitory computer readable medium of example 8, wherein the instructions, when executed, further cause the at least one processor to, in response to a generation of the additional model structures, generate a structure to aggregate output data for every exit point.

Example 16 includes the at least one non-transitory computer readable medium of example 15, wherein the instructions, when executed, further cause the at least one processor to aggregate the data into an array of the output and confidence score associated with each exit location.

Example 17 includes the at least one non-transitory computer readable medium of example 15, wherein the instructions, when executed, further cause the at least one processor to indicate whether an adversarial attack has been detected.

Example 18 includes an apparatus for generating an ensemble model from a trained machine learning model, the apparatus comprising means for acquiring a model, means for identifying a number of exit points to place in the model, means for selecting exit points to be enabled in the model, and means for generating an additional model structure to calculate an output at each respective exit point.

Example 19 includes a method of generating an ensemble model from a trained machine learning model, the method comprising acquiring, by executing an instruction with a processor, the model, identifying, by executing an instruction with the processor, a number of exit points to place in the model, selecting, by executing an instruction with the processor, exit points to be enabled in the model, and generating, by executing an instruction with the processor, an additional model structure to calculate an output at each respective exit point.

Example 20 includes the method of example 19, wherein the model includes multiple trained models.

Example 21 includes the method of example 20, wherein the identifying of the number of exit points to place in the model includes using a count of convolutional layers in the model.

Example 22 includes the method of example 20, identifying the number of exit points to place in the model includes mapping a type of layer to the number of exit points.

Example 23 includes the method of example 20, wherein the selecting of the exit points includes identifying a set of exit locations out of a set of varying exit locations using cross entropy loss.

Example 24 includes the method of example 20, wherein the generating of the additional model structure to calculate an output at each exit point includes inserting a fully connected layer and a softmax layer.

Example 25 includes the method of example 20, wherein the generating of the additional model structure at each exit point to calculate an output incorporates a calculated importance weight at each exit point.

Example 26 includes the method of example 20, wherein the method further including, in response to a generation of the additional model structures, generating a structure to aggregate output data for every exit point.

Example 27 includes the method of example 26, further including structuring an array of the output and confidence score associated with each exit location.

Example 28 includes the method of example 26, further including indicating whether an adversarial attack has been detected.

Example 29 includes an apparatus to detect an adversarial attack against a machine learning model, the apparatus comprising an ensemble model generator to generate an ensemble model from a trained model, an ensemble model executor to generate an output from the ensemble model, and an adversarial attack identifier to determine whether an adversarial attack has occurred based on the output from the ensemble model.

Example 30 includes the apparatus of example 29, wherein the ensemble model executor includes a data point accumulator to generate a structure to aggregate output data for exit points in the ensemble model.

Example 31 includes the apparatus of example 30, wherein the data point accumulator is to generate a structure to aggregate data for exit points in the ensemble model using a set of output values and confidence scores associated with exit locations in the ensemble model.

Example 32 includes the apparatus of example 30, wherein the data point accumulator is to generate a structure to aggregate data for exit points in the ensemble model using a weighted average of the output at the exit points.

Example 33 includes the apparatus of example 29, wherein the adversarial attack identifier is to determine whether an adversarial attack has occurred using a calculation of a distribution of confidence scores output by exit locations in the ensemble model.

Example 34 includes the apparatus of example 29, wherein the adversarial attack identifier is to determine whether an adversarial attack has occurred using a count of classifications output by exit locations in the ensemble model.

Example 35 includes the apparatus of example 29, further including an adversarial attack indicator to indicate whether an adversarial attack has occurred.

Example 36 includes At least one non-transitory computer readable medium comprising instructions that, when executed, cause at least one processor to at least generate an ensemble model from a trained model, execute the ensemble model to generate an output from the ensemble model, and identify whether an adversarial attack has occurred based on the output from the ensemble model.

Example 37 includes the at least one non-transitory computer readable medium of example 36, wherein the instructions, when executed, cause the at least one processor to generate a structure to aggregate output data for exit points in the ensemble model.

Example 38 includes the at least one non-transitory computer readable medium of example 37, wherein the instructions, when executed, cause the at least one processor to generate a structure to aggregate output data for exit points in the ensemble model using a set of output values and confidence scores associated with exit locations in the ensemble model.

Example 39 includes the at least one non-transitory computer readable medium of example 37, wherein the instructions, when executed, cause the at least one processor to generate a structure to aggregate output data for exit points in the ensemble model using a weighted average of the output at the exit points.

Example 40 includes the at least one non-transitory computer readable medium of example 36, wherein the instructions, when executed, cause the at least one processor to identify whether an adversarial attack has occurred using a calculation of a distribution of confidence scores output by exit locations in the ensemble model.

Example 41 includes the at least one non-transitory computer readable medium of example 36, wherein the instructions, when executed, cause the at least one processor to identify whether an adversarial attack has occurred using a count of classifications output by exit locations in the ensemble model.

Example 42 includes the at least one non-transitory computer readable medium of example 36, wherein the instructions, when executed, further cause the at least one processor to indicate whether an adversarial attack has occurred.

Example 43 includes a method of detecting an adversarial attack against a machine learning model, the method comprising generating, by executing an instruction with a processor, an ensemble model from a trained model, executing, by executing an instruction with a processor, the ensemble model to generate an output from the ensemble model, and identifying, by executing an instruction with a processor, whether an adversarial attack has occurred based on the output from the ensemble model.

Example 44 includes the method of example 43, wherein the executing the ensemble model includes a data point accumulator to generate a structure to aggregate output data for exit points in the ensemble model.

Example 45 includes the method of example 44, wherein the structure to aggregate the output data generated by the data point accumulator includes a set of output values and confidence scores associated with exit locations in the ensemble model.

Example 46 includes the method of example 44, wherein the generating the structure to aggregate output data for exit points in the ensemble model uses a weighted average of the output at the exit points.

Example 47 includes the method of example 43, wherein the identifying whether an adversarial attack has occurred uses a calculation of a distribution of confidence scores output by exit locations in the ensemble model.

Example 48 includes the method of example 43, wherein the identifying whether an adversarial attack has occurred uses a count of classifications output by exit locations in the ensemble model.

Example 49 includes the method of example 43, further including providing a determination whether an adversarial attack has occurred to an adversarial attack indicator. Although certain example methods, apparatus and articles of manufacture have been disclosed herein, the scope of coverage of this patent is not limited thereto. On the contrary, this patent covers all methods, apparatus and articles of manufacture fairly falling within the scope of the claims of this patent.

The following claims are hereby incorporated into this Detailed Description by this reference, with each claim standing on its own as a separate embodiment of the present disclosure.

1. An apparatus to generate an ensemble model from a trained machine learning model, the apparatus comprising:
a model acquirer to acquire the model;
an exit point quantity identifier to determine a number of exit points to place in the model;
an exit point selector to select exit points to be enabled in the model; and
an exit output generator to generate an additional model structure to calculate an output at each respective exit point.

2. The apparatus of claim 1, wherein the model obtained by the model acquirer includes multiple trained models.

3. The apparatus of claim 1, wherein the exit point quantity identifier is to determine the number of exit points to be placed using a count of convolutional layers in the model.

4. The apparatus of claim 1, wherein the exit point quantity identifier is to determine the number of exit points to be placed by mapping a type of layer to the number of exit points.

5. The apparatus of claim 1, wherein the exit point selector identifies the exit points using cross entropy loss.

6. The apparatus of claim 1, wherein the exit output generator creates the additional model structure using an insertion of a fully connected layer and a softmax layer.

7. The apparatus of claim 1, wherein the exit output generator creates the additional model structure at each exit point that incorporates a calculated importance weight.

8. At least one non-transitory computer readable medium comprising instructions that, when executed, cause at least one processor to at least:
acquire a model;
identify a number of exit points to place in the model;
select exit points to be enabled in the model; and
generate an additional model structure to calculate an output at each respective exit point.

9. The at least one non-transitory computer readable medium of claim 8, wherein the instructions, when executed, cause the at least one processor to acquire the model by acquiring multiple trained models.

10. The at least one non-transitory computer readable medium of claim 8, wherein the instructions, when executed, cause the at least one processor to identify a number of exit points by counting a number of convolutional layers in the model.

11. The at least one non-transitory computer readable medium of claim 8, wherein the instructions, when executed, cause the at least one processor to identify the number of exit points by mapping a type of layer to the number of exit points.

12. The at least one non-transitory computer readable medium of claim 8, wherein the instructions, when executed, cause the at least one processor to select the exit points that will be enabled in the model by identifying a set of exit locations out of a set of varying exit locations using cross entropy loss.

13. The at least one non-transitory computer readable medium of claim 8, wherein the instructions, when executed, cause the at least one processor to generate the additional model structure by inserting a fully connected layer and a softmax layer at each exit point.

14. The at least one non-transitory computer readable medium of claim 8, wherein the instructions, when executed, cause the at least one processor to generate the additional model structures at each exit point by incorporating a calculated importance weight.

15. The at least one non-transitory computer readable medium of claim 8, wherein the instructions, when executed, further cause the at least one processor to, in response to a generation of the additional model structures, generate a structure to aggregate output data for every exit point.

16. The at least one non-transitory computer readable medium of claim 15, wherein the instructions, when executed, further cause the at least one processor to aggregate the data into an array of the output and confidence score associated with each exit location.

17. The at least one non-transitory computer readable medium of claim 15, wherein the instructions, when executed, further cause the at least one processor to indicate whether an adversarial attack has been detected.

18. An apparatus for generating an ensemble model from a trained machine learning model, the apparatus comprising:
means for acquiring a model;
means for identifying a number of exit points to place in the model;
means for selecting exit points to be enabled in the model; and
means for generating an additional model structure to calculate an output at each respective exit point.

19. A method of generating an ensemble model from a trained machine learning model, the method comprising:
acquiring, by executing an instruction with a processor, the model;
identifying, by executing an instruction with the processor, a number of exit points to place in the model;
selecting, by executing an instruction with the processor, exit points to be enabled in the model; and
generating, by executing an instruction with the processor, an additional model structure to calculate an output at each respective exit point.

20. The method of claim 19, wherein the model includes multiple trained models.

21-49. (canceled)
